(19) United States
(12) Patent Application Publication
(10) Pub. No.: US 2010/0287798 A1
(43) Pub. Date: Nov. 18, 2010

(54) Swing thought clip

(76) Inventor: Chester L. Marianetti, Rochester, NY (US)

Correspondence Address: CHESTER L. MARIANETTI, 1326 A Emerson St, Rochester, NY, 14606, US

(21) Appl. No.: 12/380,883

(22) Filed: Apr. 16, 2009

Related U.S. Application Data
(60) Provisional application No. 61/128,306, filed on May 21, 2008.

(51) Int. Cl. A63B 57/00; G09F 3/16

(52) U.S. Cl. 40/1

(57) ABSTRACT

The Swing Thought Clip is a leather tag with a metal clip attached to the back of it. This tag is designed to attach to the top rim of a golf bag by pulling the metal clip open and placing it over the rim of the bag. The front of the leather tag has a clear plastic window and an opening at the top. Inside the tag are removable cards onto which you can print one or two thoughts to focus on. Left arm straight, full turn, head still, and hold finish are some common swing thoughts that might be used. Because it attaches to the top rim of your golf bag, every time you reach for a club you are reminded of your swing keys. The Swing Thought Clip was designed to help golfers stay focused and play better golf.

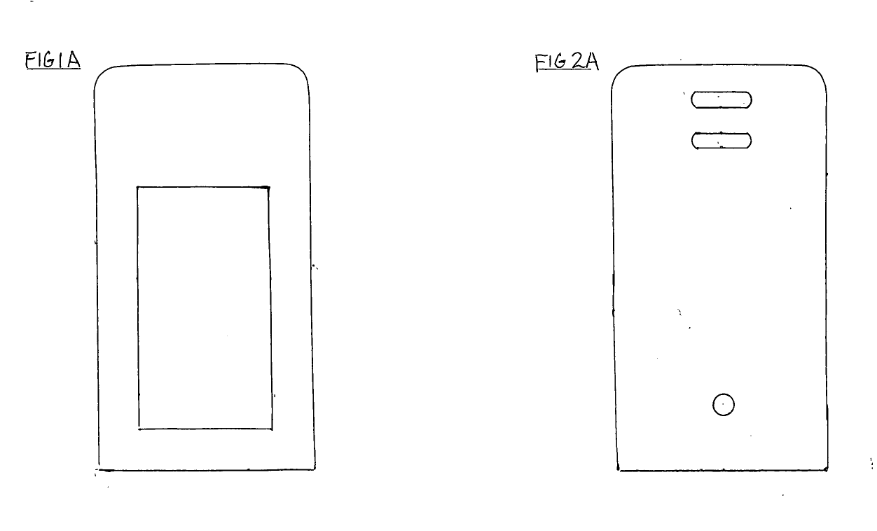

FIG. 1A The front piece of the Swing Thought Clip showing window cut out.

FIG. 1B The outside dimensions of the front piece are 3¾″ long and 2″ wide. The window shown is 2¼″ long and 1¼″ wide. The window is 3/8″ from the bottom, 3/8″ from the sides, and 1⅛″ from the top.

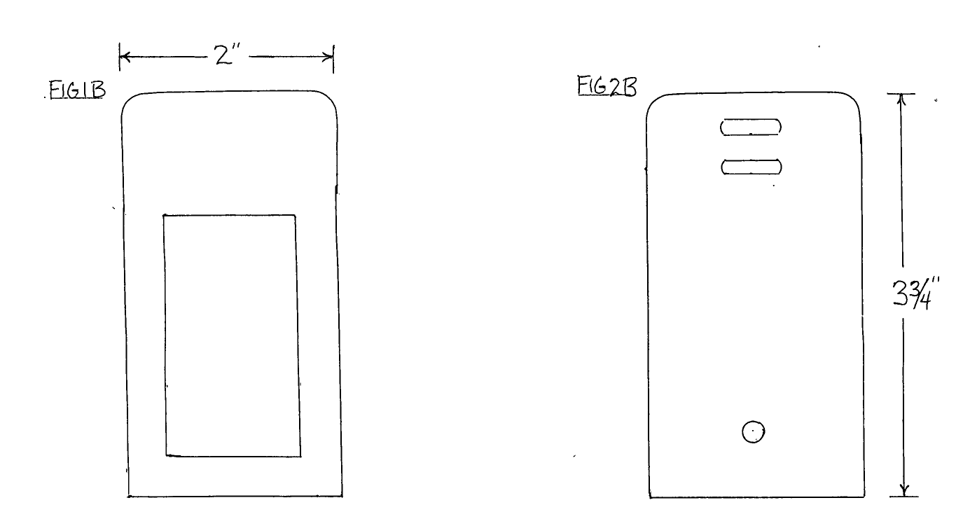

FIG. 2A The back piece of the Swing Thought Clip showing two slots which the metal clip is woven through and ⅛″ hole near the bottom where the rivet fits through to attach the metal clip.

FIG. 2B The outside dimensions of the back piece are 3¾″ long and 2″ wide. The two slots shown are centered and are ½″ long and ⅛″ wide. These slots are ¼″ from the top and ¼″ apart from each other. At the bottom of this piece is a ⅛″ hole centered. This hole is ⅝″ from the bottom.

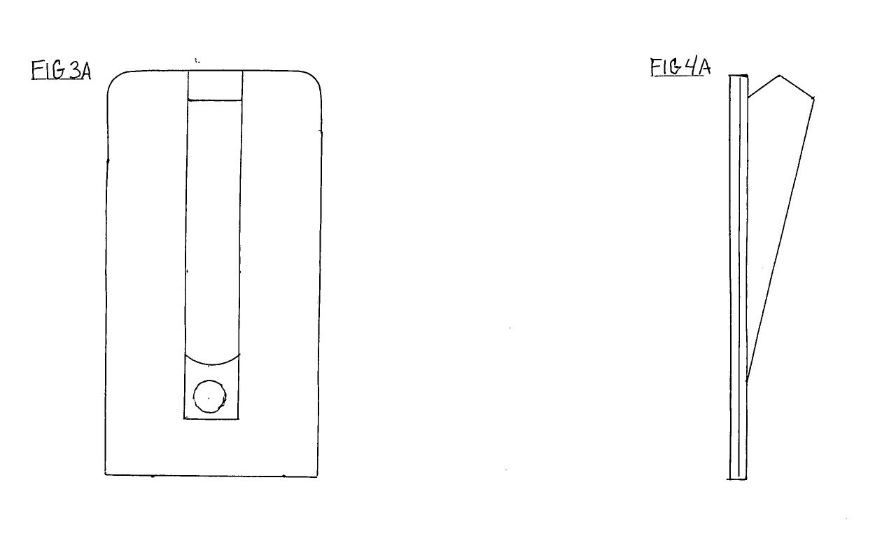

FIG. 3A The back view of the Swing Thought Clip with the metal clip attached with a rivet near the bottom of the clip.

FIG. 3B The outside dimensions of the back piece showing the metal clip attached are 3¾″ long and 2″ wide. The backside of the metal clip is 3¼″ long and ½″ wide. The backside of the metal clip is woven through the two slots and attached at the bottom with a rivet. The flexible piece of the metal clip is 2⅞″ long.

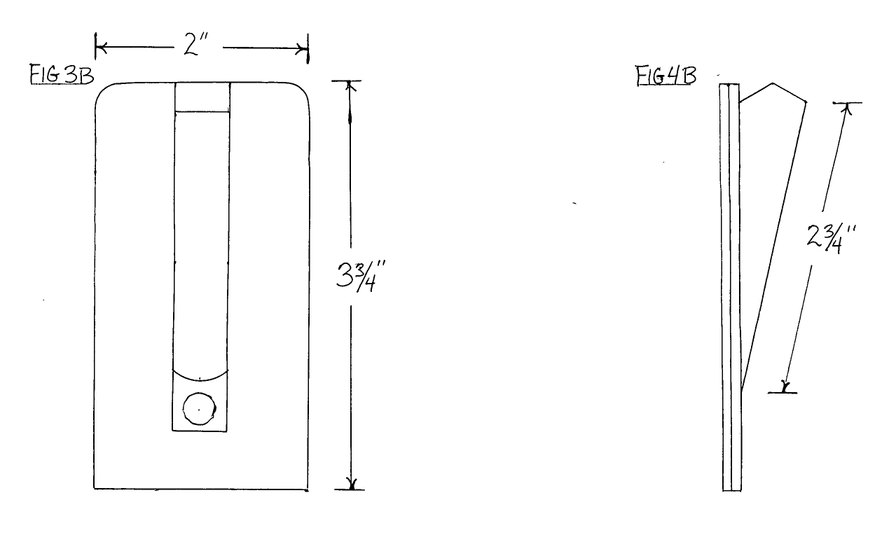

FIG. 4A The side view of the Swing Thought Clip with the metal clip attached showing the two pieces sewn together on three sides leaving an opening at the top.

FIG. 4B The dimensions of the side view of the Swing Thought Clip are 3¾″ long and ⅛″ wide. This view shows the flexible piece of the metal clip. The bend in the metal clip is ⅝″ leaving a flexible straight piece which is 2¾″ in length.

The substitute specification contains no new matter. The size, shape, and dimensions of the Swing Thought Clip are exactly the same as the original.

What is claimed is:

1. It is a tag apparatus for attachment to a golf bag.
a. Said tag has a back side with a metal clip that attaches to the rim of a golf bag.
b. Said tag has a front side with a clear plastic window.
c. Both sides are attached with an opening at the top into which cards can be inserted and viewed through the plastic window.
d. The removable cards are to be used to contain hand printed messages such as: Left arm straight, full turn, head still, hold finish, etc.
